(19) United States
(12) Patent Application Publication
(10) Pub. No.: US 2014/0197297 A1
(43) Pub. Date: Jul. 17, 2014

(54) BOOM SPRAYER AND BOOM RAISING AND LOWERING DEVICE

(71) Applicant: KAYABA INDUSTRY CO., LTD., Tokyo (JP)

(72) Inventors: Tatsuo ITO, Sagamihara-shi (JP); Takanori INADA, Sagamihara-shi (JP); Takanobu YOSHIDA, Saitama-shi (JP); Tomomichi MIZUKAMI, Tokorozawa-shi (JP); Atsushi OOTA, Morioka-shi (JP); Daiki SHIBASAKI, Iruma-shi (JP); Masaki AKASHI, Inzai-shi (JP); Yasuo TANAKA, Toda-shi (JP)

(73) Assignee: KAYABA INDUSTRY CO., LTD., Tokyo (JP)

(21) Appl. No.: 14/152,957

(22) Filed: Jan. 10, 2014

(30) Foreign Application Priority Data
Jan. 11, 2013 (JP) 2013-3997

(51) Int. Cl. A01B 63/10; A01M 7/00; B05B 1/20

(52) U.S. Cl. CPC A01B 63/1006; B05B 1/20; A01M 7/0057
USPC 248/550; 248/277.1

(57) ABSTRACT

A boom raising and lowering device that is configured to raise and lower a boom includes a raising and lowering mount that is provided so as to be able to be raised and lowered with respective to the working vehicle, a roll mount that is provided on the raising and lowering mount so as to be rotatable in a roll direction and that supports the boom in a cantilever-supported manner, a first raising and lowering actuator that drives one end of the roll mount in the vertical direction with respective to the working vehicle, and a second raising and lowering actuator that drives other end of the roll mount in the vertical direction with respective to the working vehicle. The boom is driven in the vertical direction and roll direction by operating the first raising and lowering actuator and the second raising and lowering actuator.

### TECHNICAL FIELD

The present invention relates to a boom sprayer and a boom raising and lowering device.

### BACKGROUND ART

JP2004-254526A discloses a boom sprayer. This boom sprayer includes a boom support frame that is raised and lowered by a raising and lowering linkage mechanism provided on a front side of a working vehicle, a rocking shaft that is provided on the boom support frame and extends in the front-to-rear direction, left and right booms that are cantilever-supported on the rocking shaft in a rollable manner, a hydraulic cylinder that is interposed between the boom support frame and the boom, a tilt detector that detects the tilt angle of the working vehicle, a rocking-angle detector that detects the boom-rocking angle against the boom support frame, and a control device that controls the extension and contraction of the hydraulic cylinder.

The raising and lowering linkage mechanism is driven by left and right raising and lowering cylinders provided on the left and right sides of the working vehicle. When the boom sprayer is operated, if the heights of the booms are to be changed, the left and right raising and lowering cylinders are extended and contracted in a synchronous manner to raise and lower the boom support frame. By doing so, the heights of the booms from a crop plant in a field are adjusted.

When the boom sprayer is operated, in the case where the working vehicle is tilted in a roll direction, the booms supported on the raising and lowering linkage mechanism also tend to tilt in the same direction. The control device controls the extension and contraction of the hydraulic cylinder in accordance with the detected signals from the tilt detector and the rocking-angle detector such that the tilt angles of the left and right booms become set values. By doing so, the booms are maintained at the horizontal posture or at a set angled posture.

### SUMMARY OF INVENTION

With the above-mentioned conventional boom sprayer, the left and right raising and lowering cylinders that adjust the heights of the booms and single hydraulic cylinder that adjusts the tilt of the booms in the roll direction are provided as the actuators for driving the booms. Therefore, the number of actuators is increased, causing complication of the structure.

The object of the present invention is to provide a boom sprayer and a boom raising and lowering device that are capable of adjusting the height and roll angle of a boom by a pair of left and right actuators.

According to one aspect of the present invention, a boom raising and lowering device that is configured to raise and lower a boom that is cantilever-supported on a working vehicle is provided. The boom raising and lowering device includes a raising and lowering mount that is provided so as to be able to be raised and lowered with respective to the working vehicle, a roll mount that is provided on the raising and lowering mount so as to be rotatable in a roll direction and that cantilever-supports the boom, a first raising and lowering actuator that drives one end of the roll mount in a vertical direction with respective to the working vehicle, and a second raising and lowering actuator that drives other end of the roll mount in the vertical direction with respective to the working vehicle. The boom is driven in the vertical direction and roll direction by operating the first raising and lowering actuator and the second raising and lowering actuator.

### BRIEF DESCRIPTION OF DRAWINGS

FIG. 1 is a plan view of a boom sprayer according to an embodiment of the present invention;

FIG. 2 is a side view of the boom sprayer according to the embodiment of the present invention; and

FIG. 3 is a perspective view of the boom sprayer according to the embodiment of the present invention.

### DESCRIPTION OF EMBODIMENTS

Embodiments of the present invention and advantages thereof are described in detail below with reference to the accompanying drawings.

For the sake of convenience of explanation, three mutually orthogonal axes, X, Y, and Z, are set on the attached drawings. X-axis extends in the front-to-rear direction (substantially horizontal longitudinal direction) of a vehicle, Y-axis extends in the left-to-right direction (substantially horizontal lateral direction) of the vehicle, and Z-axis extends in the vertical direction (substantially upright direction) of the vehicle. A rotation direction centered at the X-axis is referred to as a roll direction, and a rotation direction centered at the Z-axis is referred to as a yaw direction.

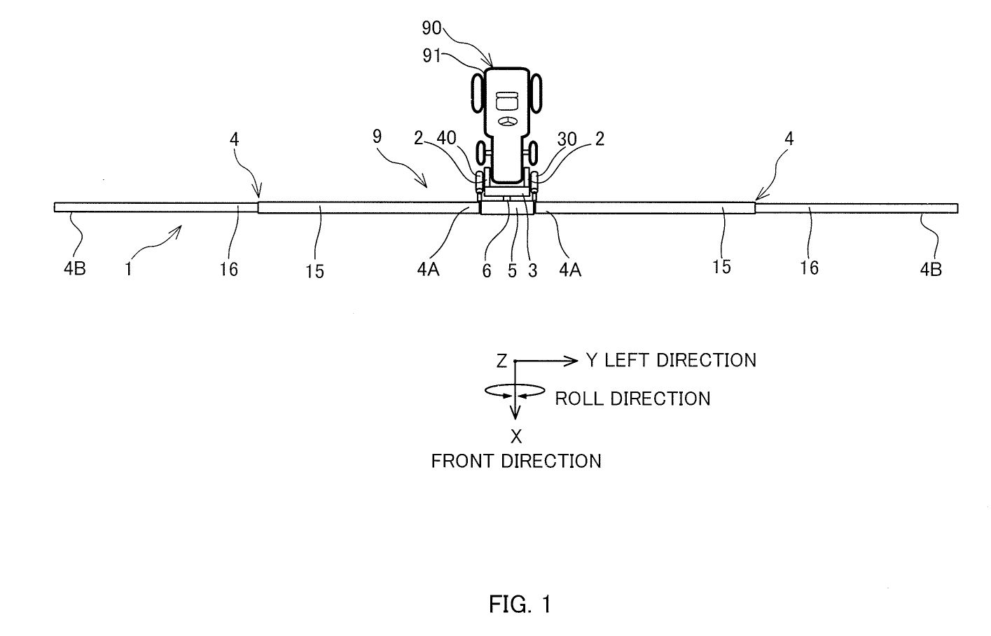

A boom sprayer 1 shown in FIG. 1 is an agricultural working machine that is mounted on the front side of a working vehicle (tractor) 90 that runs in a field and that sprays pest control fluid (agricultural chemicals) from the working vehicle 90.

The boom sprayer 1 includes a pair of booms 4 that extend in the left and right directions from the working vehicle 90. The booms 4 include nozzles (not shown) for spraying pest control fluid. During the operation of the boom sprayer 1, a pest control fluid is sprayed from the nozzles of the booms 4 while the working vehicle 90 is running in a field.

The boom sprayer 1 includes a boom raising and lowering device 9 that raises and lowers the booms 4 in the vertical direction and roll direction. The boom raising and lowering device 9 includes linkage arms 2 that are attached to a vehicle body 91, a raising and lowering mount 3 that is supported on the vehicle body 91 with the linkage arms 2 so as to be able to be raised and lowered, a roll mount 5 that is supported on the raising and lowering mount 3 so as to be rotatable in the roll direction (about the X-axis), and the left and right booms 4 that extend from the roll mount 5 in the left and right directions (the Y-axis direction) of the vehicle body 91.

The roll mount 5 forms a support part for the booms 4, which cantilever-supports each of the left and right booms 4 with respect to the raising and lowering mount 3.

Base-end portions 4A of the booms 4 are cantilever-supported on the roll mount 5 via retractable hinges (not shown) so as to be rotatable in the yaw direction (about the Z-axis). Tip-end portions 4B of the booms 4 are free ends. The booms 4 include base-end side frames 15 having the base-end portions 4A and tip-end side frames 16 having the tip-end portions 4B, and the tip-end side frames 16 are supported on the base-end side frames 15 so as to be extendable and contractable.

In an extended state shown in FIG. 1, the left and right booms 4 extend horizontally in the left and right directions of the working vehicle 90. With this extended state, the length (width) between the tip ends of the left and right booms 4 is, for example, 10 to 20 meters. When the booms 4 are to be retracted, the booms 4 are contracted from the operational position so as to have about halved projected length, and thereafter, the booms 4 are rotated towards the rear direction via the retractable hinges. By doing so, the booms 4 are folded so as to extend in the front-to-rear direction along the side of the vehicle body 91.

The roll mount 5 is supported on the raising and lowering mount 3 so as to be rotatable in the roll direction via a support shaft 6. Although the support shaft 6 is a cylindrical pin, it is not limited thereto, and a spherical bearing etc. may be used.

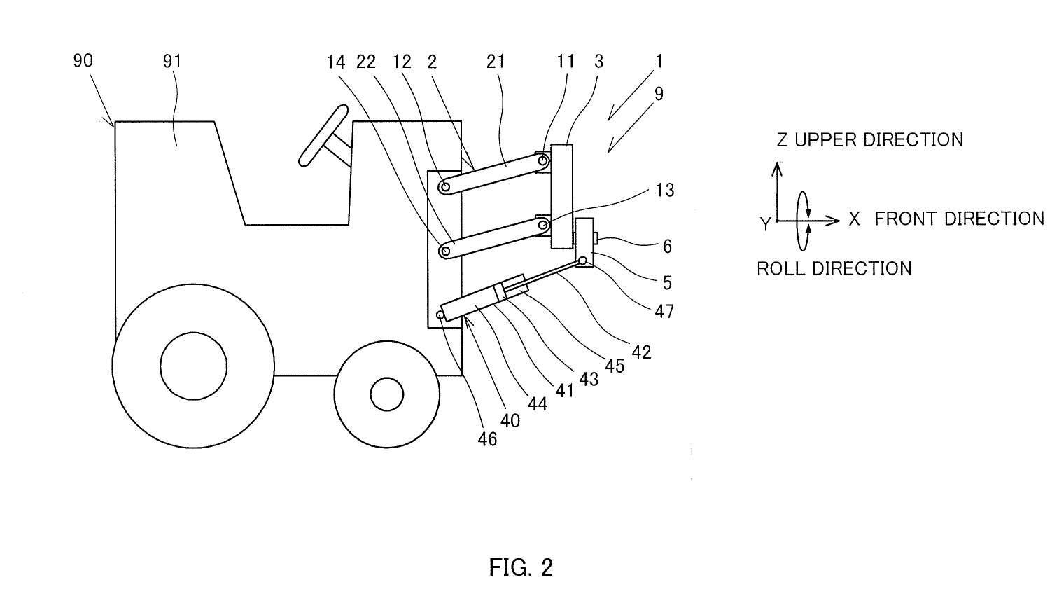

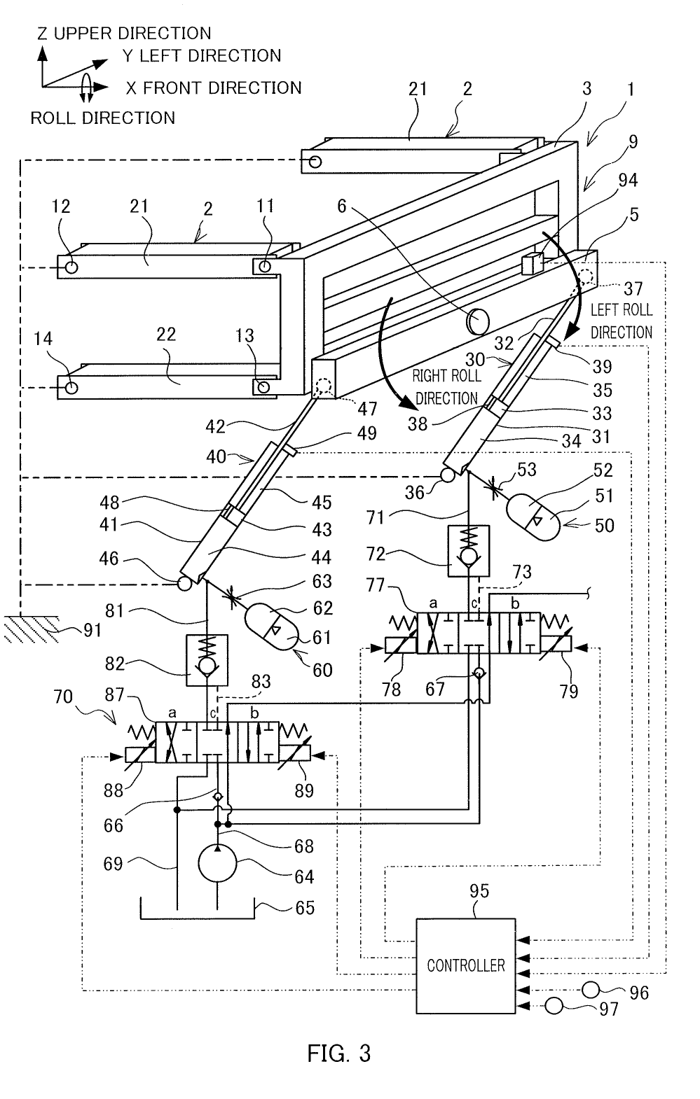

FIG. 2 is a side view schematically showing the configuration of the boom sprayer 1. FIG. 3 is a perspective view showing the vicinity of the raising and lowering mount 3. The boom sprayer 1 includes a pair of linkage arms 2 at both of the left and right side portions of the vehicle body 91. The linkage arms 2 have upper linkages 21 and lower linkages 22 that extend in parallel to each other, and the linkage arms 2 form a linkage mechanism having a parallelogram shape when viewed from the side.

Base-end portions of the upper linkages 21 are rotatably linked to the vehicle body 91 via pins 12, and tip-end portions of the upper linkages 21 are rotatably linked to the raising and lowering mount 3 via pins 11. Base-end portions of the lower linkages 22 are rotatably linked to the vehicle body 91 via pins 14, and tip-end portions of the lower linkages 22 are rotatably linked to the raising and lowering mount 3 via pins 13.

The raising and lowering mount 3 is supported by each of the linkage arms 2 at the front part of the vehicle body 91 so as to be able to be raised and lowered. Instead of this configuration, it is possible to employ a configuration in which a guide rail extending in the Z-axis direction may be provided on the front part of the vehicle body 91, and this guide rail may be used to support the raising and lowering mount 3 so as to be able to be raised and lowered.

A first fluid pressure cylinder 30 that drives the left-side end of the roll mount 5 in the vertical direction with respective to the vehicle body 91 is provided on the left side of the vehicle body 91. A second fluid pressure cylinder 40 that drives the right-side end of the roll mount 5 in the vertical direction with respective to the vehicle body 91 is provided on the right side of the vehicle body 91.

The roll mount 5 and the raising and lowering mount 3 are raised and lowered by extending and contracting the first fluid pressure cylinder 30 and the second fluid pressure cylinder 40 in the same direction in synchronization.

The roll mount 5 is rotated in the roll direction with respective to the raising and lowering mount 3 by extending and contracting the first fluid pressure cylinder 30 and the second fluid pressure cylinder 40 in the opposite directions in synchronization.

The first fluid pressure cylinder 30, serving as a first raising and lowering actuator, includes a first cylinder tube 31 filled with a hydraulic oil, a first piston rod 32 that is slidably inserted into the first cylinder tube 31, and a piston 33 that is provided on the base-end portion of the first piston rod 32. The base-end portion of the first cylinder tube 31 is rotatably linked to the vehicle body 91 via a spherical bearing 36, and the tip-end portion of the first piston rod 32 is rotatably linked to the left-side end of the roll mount 5 via a spherical bearing 37.

The interior of the first cylinder tube 31 is partitioned into a bottom-side chamber 34 and a head-side chamber 35 by the piston 33. A flow channel 38 is formed in the piston 33 for allowing the flow of the hydraulic oil between the head-side chamber 35 and the bottom-side chamber 34. The first fluid pressure cylinder 30 is a single-acting fluid pressure cylinder that is extended and contracted in response to the supply/discharge of the hydraulic oil to/from the bottom-side chamber 34 and the head-side chamber 35 in the first cylinder tube 31.

The second fluid pressure cylinder 40, serving as a second raising and lowering actuator, includes a second cylinder tube 41 filled with the hydraulic oil, a second piston rod 42 that is slidably inserted into the second cylinder tube 41, and a piston 43 that is provided on the base-end portion of the second piston rod 42. The base-end portion of the second cylinder tube 41 is rotatably linked to the vehicle body 91 via a spherical bearing 46, and the tip-end portion of the second piston rod 42 is rotatably linked to the right-side end of the roll mount 5 via a spherical bearing 47.

The inside of the second cylinder tube 41 is partitioned by the piston 43 into a bottom-side chamber 44 and a head-side chamber 45. A flow channel 48 is formed in the piston 43 for allowing the flow of the hydraulic oil between the head-side chamber 45 and the bottom-side chamber 44. The second fluid pressure cylinder 40 is a single-acting fluid pressure cylinder that is extended and contracted in response to the supply/discharge of the hydraulic oil to/from the bottom-side chamber 44 and the head-side chamber 45 in the second cylinder tube 41.

It is also possible to employ a configuration in which the piston rods 32 and 42 are linked to the working vehicle 90 and the cylinder tubes 31 and 41 are linked to the roll mount 5.

In addition, although the hydraulic oil is used as the hydraulic fluid in the first and second fluid pressure cylinders 30 and 40, a working fluid, such as, for example, an alternative aqueous fluid etc., or gas may by used instead of the hydraulic oil.

The spherical bearings 36, 37, 46, and 47 are formed of, for example, a ball and a spherical bearing that slidably supports this ball. Because the first and second fluid pressure cylinders 30 and 40 are supported by the spherical bearings 36, 37, 46, and 47, prying force is prevented from occurring at the linkage portions and smooth extension and contraction is achieved.

The boom sprayer 1 includes a hydraulic-fluid supply and discharge device 70 that supplies/discharges the hydraulic oil into/from the bottom-side chamber 34 of the first fluid pressure cylinder 30 and the bottom-side chamber 44 of the second fluid pressure cylinder 40. The hydraulic-fluid supply and discharge device 70 supplies/discharges the hydraulic oil into/from the first and second fluid pressure cylinders 30 and 40, thereby causing the first and second fluid pressure cylinders 30 and 40 to extend and contract.

The configuration of the hydraulic-fluid supply and discharge device 70 is not limited to that in which the hydraulic oil is supplied/discharged to/from respective bottom-side chambers 34 and 44 of the first and second fluid pressure cylinders 30 and 40, and it is possible to employ a configuration in which the hydraulic oil is supplied/discharged to/from respective head-side chambers 35 and 45.

In addition, it is possible to employ a configuration in which the hydraulic-fluid supply and discharge device 70 supplies/discharges the hydraulic oil into/from the respective bottom-side chambers 34 and 44 of the first and second fluid pressure cylinders 30 and 40 and supplies/discharges the hydraulic oil into/from the respective head-side chambers 35 and 45.

The hydraulic-fluid supply and discharge device 70 includes supply/discharge channels 71 and 81 that are in communication with the respective bottom-side chambers 34 and 44 of the first and second fluid pressure cylinders 30 and 40, pilot operated check valves 72 and 82 that are respectively interposed at the supply/discharge channels 71 and 81, and first and second direction selector valves 77 and 87 that switch the respective communications of the supply/discharge channels 71 and 81 to a hydraulic pump 64 (fluid pressure source) and a tank 65.

The first and second direction selector valves 77 and 87 are respectively connected to a supply channel 68 that guides the hydraulic oil discharged from the hydraulic pump 64, a discharge channel 69 that returns the hydraulic oil to the tank 65, operation channels 73 and 83 that are in communication with pilot pressure chambers of respective pilot operated check valves 72 and 82, and the supply/discharge channels 71 and 81 that are respectively in communication with the bottom-side chambers 34 and 44. Check valves 66 and 67 are respectively interposed at connecting portions to the first and second direction selector valves 77 and 87 in the supply channel 68, thereby preventing reverse flow of the hydraulic oil toward the pump.

The electromagnetically-switched first and second direction selector valves 77 and 87 have an extention position a, a contraction position b, and a neutral position c. With the first direction selector valve 77, the positions are switched by the driving current sent to solenoids 78 and 79 from a controller 95. With the second direction selector valve 87, the positions are switched by the driving current sent to solenoids 88 and 89 from the controller 95.

When the first and second direction selector valves 77 and 87 are switched to the extention position a, the discharge channel 69 is allowed to be in communication with each of the operation channels 73 and 83 and the supply/discharge channels 71 and 81 are respectively allowed to be in communication with the supply channel 68. Thus, the hydraulic oil pumped from the hydraulic pump 64 flows into each of the bottom-side chambers 34 and 44 through the supply channel 68 and each of the supply/discharge channels 71 and 81. By doing so, the first and second fluid pressure cylinders 30 and 40 are respectively extended.

When the first and second direction selector valves 77 and 87 are switched to the contraction position b, the operation channels 73 and 83 are respectively allowed to be in communication with the supply channel 68 and the supply/discharge channels 71 and 81 are respectively allowed to be in communication with the discharge channel 69. Thus, a pump pressure of the hydraulic pump 64 is guided to the respective pilot operated check valves 72 and 82 as a pilot pressure through the operation channels 73 and 83 to open each of the pilot operated check valves 72 and 82. Furthermore, the hydraulic oil in each of the bottom-side chambers 34 and 44 is discharged to the tank 65 through the respective supply/discharge channels 71 and 81 and the discharge channel 69. By doing so, the first and second fluid pressure cylinders 30 and 40 are respectively contracted.

When the first and second direction selector valves 77 and 87 are switched to the neutral position c, the supply channel 68, the discharge channel 69, each of the operation channels 73 and 83, and each of the supply/discharge channels 71 and 81 are respectively closed. By doing so, the hydraulic oil is prevented from flowing in and out of each of the bottom-side chambers 34 and 44 and each of the pilot operated check valves 72 and 82 is closed, and therefore, the first and second fluid pressure cylinders 30 and 40 are respectively stopped.

First and second stroke detectors 39 and 49 are provided on the first and second fluid pressure cylinders 30 and 40 for detecting respective strokes (lengths) thereof. The detection signals from the first and second stroke detectors 39 and 49 are sent to the controller 95.

An operation panel (not shown) of the working vehicle 90 includes a set-height command unit 96 that gives a command for the set height of the booms 4 and a set-roll-angle command unit 97 that instructs the set roll angle of the booms 4. When a driver operates the set-height command unit 96 and the set-roll-angle command unit 97, a command signal for the set height of the booms 4 and a command signal for the set roll angle are sent to the controller 95.

The controller 95 calculates the height and roll angle of the booms 4 in accordance with the detection signals from the first and second stroke detectors 39 and 49 and performs switching control of the positions of the first and second direction selector valves 77 and 87, respectively, such that the calculated height and roll angle of the booms 4 approach the set height and the set roll angle that are commanded.

When a driver operates the set-height command unit 96 to instruct the set height of the booms 4, the controller 95 is switched to a raising and lowering control mode for changing the heights of the booms 4. With the raising and lowering control mode, the controller 95 causes the first and second fluid pressure cylinders 30 and 40 to extend and contract in the same direction in synchronization in accordance with the detection signals from the first and second stroke detectors 39 and 49.

When the first and second fluid pressure cylinders 30 and 40 are extended, the linkage arms 2 are pivoted upward, and therefore, the booms 4 are raised via the raising and lowering mount 3 and the roll mount 5. On the other hand, when the first and second fluid pressure cylinders 30 and 40 are contracted, the linkage arms 2 are pivoted downward, and therefore, the booms 4 are lowered via the raising and lowering mount 3 and the roll mount 5. By extending and contracting the first and second fluid pressure cylinders 30 and 40 in the same direction, the boom sprayer 1 can adjust the height of the booms 4 from a crop plant in a field.

When a driver operates the set-roll-angle command unit 97 to command the set roll angle of the booms 4, the controller 95 is switched to a roll control mode for changing the roll angle of the booms 4. With the roll control mode, the controller 95 causes the first and second fluid pressure cylinders 30 and 40 to extend and contract in the opposite directions in synchronization in accordance with the detection signals from the first and second stroke detectors 39 and 49.

As indicated by arrows in FIG. 3, when the working vehicle 90 is viewed from the front, the leftward rotation direction about the X-axis is described as the right roll direction (positive roll direction), and the rightward rotation direction is described as the left roll direction (negative roll direction).

In the roll control mode, when the second fluid pressure cylinder 40 is extended and the first fluid pressure cylinder 30 is contracted, the booms 4 are rolled in the left roll direction. Conversely, when the first fluid pressure cylinder 30 is extended and the second fluid pressure cylinder 40 is contracted, the booms 4 are rolled in the right roll direction. As described above, the boom sprayer 1 can adjust the set roll angle of the booms 4 in accordance with the inclination etc. in a field by extending and contracting the first and second fluid pressure cylinders 30 and 40 in the opposite directions from each other.

The roll mount 5 includes a roll angle detector 94 that detects the roll angle of the booms 4 relative to the horizontal line. The controller 95 performs a control that respectively switches the positions of the first and second direction selector valves 77 and 87 such that the roll angle of the booms 4 detected by the roll angle detector 94 approaches the set roll angle commanded by the set-roll-angle command unit 97. In the case where the posture of the booms 4 is changed in the roll direction with the change in the posture of the working vehicle 90, the controller 95 switches the positions of the first and second direction selector valves 77 and 87 in accordance with the signal from the roll angle detector 94. By doing so, the amount of hydraulic oil that is supplied/discharged to/from the first and second fluid pressure cylinders 30 and 40 is adjusted, and the roll angle of the booms 4 is kept close to the commanded set roll angle.

First and second accumulators 50 and 60 are respectively connected to the supply/discharge channels 71 and 81 for suppressing the vibration of the booms 4. The first and second accumulators 50 and 60 provide the biasing force biasing the booms 4 in the direction to which the first and second fluid pressure cylinders 30 and 40 extend, thereby suppressing the vibration of the booms 4 in the roll direction and vertical direction.

The first and second accumulators 50 and 60 include oil chambers 52 and 62 that are in communication with the bottom-side chambers 34 and 44 and accumulator portions 51 and 61 that store the compressed gas for pressurizing respective oil chambers 52 and 62. The accumulator portion 51 of the first accumulator 50 pressurizes the inside of the first cylinder tube 31 of the first fluid pressure cylinder 30 and biases the booms 4 in the right roll direction. The accumulator portion 61 of the second accumulator 60 pressurizes the inside of the second cylinder tube 41 and biases the booms 4 in the left roll direction. Instead of this configuration, it is possible to employ a configuration in which the first and second accumulators 50 and 60 are connected to the head-side chambers 35 and 45 of the first and second fluid pressure cylinders 30 and 40, respectively.

When the booms 4 are rolled in the left roll direction, the hydraulic oil in the second accumulator 60 flows into the extending second fluid pressure cylinder 40 and the hydraulic oil in the contracting first fluid pressure cylinder 30 flows into the first accumulator 50. Conversely, when the booms 4 are rolled in the right roll direction, the hydraulic oil in the first accumulator 50 flows into the extending first fluid pressure cylinder 30 and the hydraulic oil in the contracting second fluid pressure cylinder 40 flows into the second accumulator 60.

As described above, as the same amount of hydraulic oil is supplied/discharged into/from the first accumulator 50 and the second accumulator 60 with the roll of the booms 4 in the left and right roll directions, a gas pressure difference is generated between the first accumulator 50 and the second accumulator 60. The booms 4 are rolled to the position where the biasing force biasing the booms 4 in the right roll direction by the gas pressure of the first accumulator 50 and the biasing force biasing booms 4 in the left roll direction by the gas pressure of the second accumulator 60 are balanced, and are held at the set roll angle.

The configuration is not limited to that mentioned above, and it is possible to employ a configuration in which gas chambers that are filled with the compressed gas are respectively defined via free pistons in the first and second cylinder tubes 31 and 41, and the booms 4 are biased by the gas pressure in the gas chambers.

A damping valve 53, serving as a throttle, is interposed at a channel communicating the oil chamber 52 of the first accumulator 50 and the bottom-side chamber 34 of the first fluid pressure cylinder 30. The damping valve 53 provides resistance on the flow of the hydraulic oil flowing between the bottom-side chamber 34 and the oil chamber 52 with the extension and contraction of the first fluid pressure cylinder 30. By doing so, a damping force suppressing the vibration of the booms 4 in the vertical and roll directions is generated.

A damping valve 63, serving as a throttle, is interposed at a channel communicating the oil chamber 62 of the second accumulator 60 and the bottom-side chamber 44 of the second fluid pressure cylinder 40. The damping valve 63 provides resistance on the flow of the hydraulic oil flowing between the bottom-side chamber 44 and the oil chamber 62 with the extension and contraction of the second fluid pressure cylinder 40. By doing so, a damping force suppressing the vibration of the booms 4 in the vertical and roll directions is generated.

As described above, the damping valves 53 and 63 provide resistance on the hydraulic oil flowing in and out of the first and second fluid pressure cylinders 30 and 40 and achieve the damping function that suppresses the vibration of the booms 4 in the vertical and roll directions. The damping valves 53 and 63 are variable throttles in which the opening area increases as the flow rate of the passing hydraulic oil increases. It is possible to employ a configuration in which fixed throttles, such as orifices etc., are interposed instead of the damping valves 53 and 63, and the throttle-flow-channel area or the throttle-flow-channel length thereof are manually adjustable.

In the case where the working vehicle 90 runs over a rough surface and the working vehicle 90 moves in the vertical direction during the boom sprayer 1 is operated, the force that causes the booms 4 to be raised and lowered acts on the roll mount 5 through the first and second fluid pressure cylinders 30 and 40. At this time, the first and second fluid pressure cylinders 30 and 40 are extended and contracted against the gas pressure of the accumulator portions 51 and 61 due to the inertial force acting on the first and second fluid pressure cylinders 30 and 40 from the booms 4. Thus, because the change in the force acting on the roll mount 5 is moderated, the booms 4 are suppressed from being moved greatly in the vertical direction and the tip-end portions 4B of the booms 4 are prevented from hitting a field etc.

In the case where the working vehicle 90 runs over a rough surface and the posture of the working vehicle 90 is changed in the roll direction, the force that causes the booms 4 to roll in the roll direction acts on the roll mount 5 through the first and second fluid pressure cylinders 30 and 40. At this time, the first and second fluid pressure cylinders 30 and 40 are extended and contracted against the gas pressure of the accumulator portions 51 and 61 due to the inertial force acting on the first and second fluid pressure cylinders 30 and 40 from the booms 4. Thus, because the change in the force acting on the roll mount 5 is moderated, the booms 4 are prevented from being rolled excessively in the roll direction and the tip-end portions 4B of the booms 4 are prevented from hitting a field etc.

During the above operation, the damping valves 53 and 63 provide resistance on the flow of the hydraulic oil flowing in and out of the first and second accumulators 50 and 60 with the extension and contraction of the first and second fluid pressure cylinders 30 and 40, thereby suppressing the vibration of the booms 4 in the vertical and roll directions. By doing so, it is possible to prevent a pest control fluid injected from the nozzles of the booms 4 from being sprayed to a crop plant etc. in a repeated manner, and it is possible to spray a pest control fluid evenly.

According to the embodiment described above, the following effects can be obtained.

The boom raising and lowering device 9 includes the first fluid pressure cylinder 30 (first raising and lowering actuator) that drives the one end of the roll mount 5 in the vertical direction with respective to the working vehicle 90 and the second fluid pressure cylinder 40 (second raising and lowering actuator) that drives the other end of the roll mount 5 in the vertical direction with respective to the working vehicle 90. Because the booms 4 are driven in the vertical direction and roll direction by the operation of the first fluid pressure cylinder 30 and the second fluid pressure cylinder 40, the booms 4 can be raised and lowered and rolled in the roll direction by using two fluid pressure cylinders 30 and 40. Therefore, there is no need to provide another actuator other than the pair of left and right first and second fluid pressure cylinders 30 and 40, and thereby, it is possible to reduce the number of the actuator and to simplify the configuration.

Furthermore, the boom raising and lowering device 9 includes the first and second stroke detectors 39 and 49 that detect the strokes of the first and second fluid pressure cylinders 30 and 40 and the controller 95 that controls the extension and contraction of the first and second fluid pressure cylinders 30 and 40 in accordance with the detected strokes of the first and second fluid pressure cylinders 30 and 40. The controller 95 has the raising and lowering control mode in which the booms 4 are raised and lowered by extending and contracting the first and second fluid pressure cylinders 30 and 40 in the same direction in synchronization and the roll control mode in which the booms 4 are rolled in the roll direction by extending and contracting the first and second fluid pressure cylinders 30 and 40 in the opposite directions in synchronization. With such a configuration, it is possible to automatically adjust the height and roll angle of the booms 4 by the controller 95.

Furthermore, the boom raising and lowering device 9 includes the roll angle detector 94 that detects the roll angle of the booms 4. The controller 95 performs a control such that the roll angle of the booms 4 becomes equal to the set roll angle by extending and contracting the first and second fluid pressure cylinders 30 and 40 in accordance with the detected roll angle of the booms 4. By doing so, in the case where the posture of the working vehicle 90 is changed in the roll direction, the roll angle of the booms 4 is automatically adjusted by the controller 95 so as to become equal to the commanded set roll angle.

Furthermore, the boom raising and lowering device 9 includes the hydraulic-fluid supply and discharge device 70 that supplies/discharges the hydraulic oil to/from the first and second fluid pressure cylinders 30 and 40. The first and second fluid pressure cylinders 30 and 40 include the first and second cylinder tubes 31 and 41 that are linked to the working vehicle 90 and that are filled with the hydraulic fluid and the first and second piston rods 32 and 42 that are linked to the roll mount 5 and that are inserted into the inside of the first and second cylinder tubes 31 and 41. The boom raising and lowering device 9 includes the first and second accumulator portions 51 and 61 that store the compressed gas for pressurizing the inside of the first and second cylinder tubes 31 and 41. With such a configuration, in the case where the working vehicle 90 runs over a rough surface, and the working vehicle 90 is moved in the vertical direction and the posture of the working vehicle 90 is changed in the roll direction, the change in the force acting on the booms 4 from the first and second fluid pressure cylinders 30 and 40 is moderated by the gas pressure of the first accumulator portion 51 and the second accumulator portion 61. Therefore, it is possible to suppress the vibration of the booms 4 in the vertical and roll directions.

Furthermore, the boom raising and lowering device 9 includes the first and second accumulators 50 and 60 that have the first and second accumulator portions 51 and 61 and the damping valves 53 and 63 (throttles) that provide resistance on the hydraulic oil flowing in and out of the first and second accumulators 50 and 60 with the extension and contraction of the first and second fluid pressure cylinders 30 and 40. With such a configuration, because the damping force is generated by the resistance provided on the flow of the hydraulic oil by the damping valves 53 and 63, it is possible to suppress the vibration of the booms 4 in the vertical and roll directions.

Furthermore, because the vibration of the booms 4 in the vertical direction and roll direction can be suppressed, the boom sprayer 1 for spraying a pest control fluid that includes the boom raising and lowering device 9 is capable of spraying a pest control fluid evenly from the booms 4 and improving the operation speed.

The embodiments of the present invention described above are merely illustration of some application examples of the present invention and not of the nature to limit the technical scope of the present invention to the specific constructions of the above embodiments.

For example, instead of using the first and second fluid pressure cylinders 30 and 40, an electric cylinder that is extended and contracted by electromagnetic force may also be used.

Furthermore, the booms 4 are not limited to those extending to left and right from the working vehicle 90, and that extending to either left or right of the working vehicle 90 may also be used.

The present application claims a priority based on Japanese Patent Application No. 2013-003997 filed with the Japan Patent Office on Jan. 11, 2013, all the contents of which are hereby incorporated by reference.

What is claimed is:

1. A boom raising and lowering device that is configured to raise and lower a boom that is cantilever-supported on a working vehicle, comprising:
a raising and lowering mount that is provided so as to be able to be raised and lowered with respective to the working vehicle;
a roll mount that is provided on the raising and lowering mount so as to be rotatable in a roll direction and that cantilever-supports the boom;
a first raising and lowering actuator that drives one end of the roll mount in a vertical direction with respective to the working vehicle; and
a second raising and lowering actuator that drives other end of the roll mount in the vertical direction with respective to the working vehicle, wherein
the boom is driven in the vertical direction and roll direction by operating the first raising and lowering actuator and the second raising and lowering actuator.

2. A boom raising and lowering device according to claim 1, further comprising:
a first stroke detector that detects a stroke of the first raising and lowering actuator;
a second stroke detector that detects a stroke of the second raising and lowering actuator; and
a controller that controls extension and contraction of the first raising and lowering actuator and the second raising and lowering actuator in accordance with the detected strokes of the first raising and lowering actuator and the second raising and lowering actuator, wherein
the controller has a raising and lowering control mode in which the boom is raised and lowered by extending and contracting the first raising and lowering actuator and second raising and lowering actuator in same direction in synchronization and a roll control mode in which the boom is rolled in the roll direction by extending and contracting the first raising and lowering actuator and second raising and lowering actuator in opposite directions in synchronization.

3. A boom raising and lowering device according to claim 2, further comprising:
a roll angle detector that detects a roll angle of the boom, wherein
the controller performs a control such that the roll angle of the boom becomes equal to a set roll angle by extending and contracting the first raising and lowering actuator and the second raising and lowering actuator in accordance with the detected roll angle of the boom.

4. A boom raising and lowering device according to claim 1, further comprising:
a first fluid pressure cylinder, serving as the first raising and lowering actuator, having a first cylinder tube that is linked to the one of the working vehicle and the roll mount and that is filled with a hydraulic fluid and a first piston rod that is linked to the other of the working vehicle and the roll mount and that is inserted into inside of the first cylinder tube;
a second fluid pressure cylinder, serving as the second raising and lowering actuator, having a second cylinder tube that is linked to the one of the working vehicle and the roll mount and that is filled with a hydraulic fluid and a second piston rod that is linked to the other of the working vehicle and the roll mount and that is inserted into inside of the second cylinder tube;
a first accumulator portion that stores a compressed gas for pressurizing the inside of the first cylinder tube; and
a second accumulator portion that stores a compressed gas for pressurizing the inside of the second cylinder tube.

5. A boom raising and lowering device according to claim 4, further comprising:
a first accumulator that has the first accumulator portion;
a second accumulator that has the second accumulator portion; and
a throttle that provides resistance on a hydraulic fluid that flows in and out of the first accumulator and the second accumulator with extension and contraction of the first fluid pressure cylinder and the second fluid pressure cylinder.

6. A boom sprayer that is configured to spray a pest control fluid, comprising a boom raising and lowering device according to claim 1.
